(19) United States
(12) Patent Application Publication
(10) Pub. No.: US 2007/0072505 A1
(43) Pub. Date: Mar. 29, 2007

(54) Deformable mat with fibrous reinforcement for the production of thermoplastic matrix composites

(76) Inventor: Dominique Loubinoux, La Motte Servolex (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/577,939

(22) PCT Filed: Nov. 3, 2004
(86) PCT No.: PCT/FR04/02825

§ 371 Date: Dec. 15, 2006

(30) Foreign Application Priority Data
Nov. 3, 2003 (FR) 03/12898

(51) Int. Cl. B32B 3/06; B32B 37/00; A47B 9/00; B29C 65/00; B32B 9/00

(52) U.S. Cl. 442/366; 156/73.2; 108/107; 156/272.6; 156/308.2; 442/414; 428/102; 428/219

(57) ABSTRACT

A deformable mat of at least one web including at least one reinforcing substance and at least one thermoplastic substance, these substances being in a form of chopped yarns and/or continuous yarns, and the yarns being bonded together so that the mat has an elongation at break in all directions of at least 50% and preferably varying from 100 to 150%. A process for manufacturing the deformable mat forms a web of the yarns, treats the web under conditions allowing the yarns to be moderately bonded, and collects the mat obtained. The mat can be used for manufacturing composite parts by vacuum molding or compression molding.

The invention relates to a deformable mat comprising a fibrous reinforcement and a thermoplastic, intended for the production of composite parts, particularly by molding them.

The manufacture of composite parts having a fiber-reinforced thermoplastic matrix is generally carried out by molding materials that combine a reinforcing substance, especially glass, and a thermoplastic substance in filamentary form, such as nonwovens, wovens or structures consisting of noninterlaced organized yarns, which are linked together especially by knitting or are thermally bonded.

Vacuum molding or bladder molding techniques consist in coating a mold with the material, then in heating the mold, so that the thermoplastic that is in intimate contact with the surface of the mold can perfectly match the shape, and finally in cooling in order to obtain the molded part. In general, these materials exhibit cohesion allowing them to be handled without altering the way the yarns are assembled, and they are sufficiently flexible to be able to be placed correctly in the mold.

These materials are generally satisfactory for producing flat or curved molded products. However, problems arise when the parts to be obtained are highly recessed and/or of complex shape. This is because it has been found that, owing to their limited deformability both when being placed in the mold and during molding, the materials have a tendency to form pleats that affect the appearance of the molded part and its mechanical properties.

Nonwovens that can be molded are especially obtained from glass yarns on the one hand and thermoplastic yarns on the other, both of these being chopped and opened out beforehand by a suitable mechanical treatment. These nonwovens are generally obtained by mechanical lapping and carding or pneumatic lapping of said yarns to form a web, which web then undergoes a needle-punching operation in order to bond the yarns together so as to obtain sufficient cohesion to allow them to be handled. However, needle punching results in the filaments being oriented perpendicular to the plane of the nonwoven, which results in a substantial increase in the thickness with the consequences that the nonwoven is more difficult to cut, tears appear as a result of the stretching when placing it in the mold, and heating is less effective during molding owing to the presence of a substantial volume of air trapped between the yarns (around 80 to 90%) which act as a thermal insulator. The heating drawback is all the more important as it is very often necessary to stack several nonwovens on top of one another for the molding.

In wovens, knits and structures consisting of interlaced yarns, the yarns are organized in a regular fashion and consequently they have a small thickness and a high density (volume of trapped air less than about 60%). However, their deformability is not the same in all directions; although they can elongate substantially in the bias direction, the deformation in the direction of the enforcing yarns (warp and weft yarns) is, however, almost zero. At places in the mold having a deep recess or complex shape, the yarns have a tendency to move apart, resulting, in those regions of the molded part that correspond to these places, in a smaller thickness than in the other places, or even a complete absence of reinforcement and of thermoplastic. Surface irregularities may also be observed at these same places, especially irregularities in the form of asperities resulting from incomplete filling of the reliefs by the reinforcement and thermoplastic, especially because the reinforcing fibers are too taut to perfectly follow the contour of the mold. Such deficiencies are unacceptable.

The subject of the present invention is a deformable mat suitable for producing composite parts with a deep recess and/or of complex shape, comprising a fiber-reinforced thermoplastic matrix.

Another object of the invention is a process for obtaining said deformable mat, this process including a step of lightly bonding the fibers.

According to the invention, the deformable mat consists of at least one web comprising at least one reinforcing substance and at least one thermoplastic substance, these substances being in the form of chopped yarns or continuous yarns, and the yarns being bonded together so that the mat has an elongation at break in all directions of at least 50% and preferably varying from 100 to 150%.

The term “mat” is understood here to mean an element with a small thickness/area ratio and exhibiting sufficient flexibility to be deposited inside a mold without forming pleats.

The mat according to the invention is also characterized in that it is relatively dense. It has a density intermediate between that of structures consisting of organized yarns (wovens and structures bonded together by stitch-bonding or thermal bonding) and the nonwovens described above. The dense nature of the mat is given here by its porosity, which as a general rule varies from 65 to 80%.

The porosity of the mat is defined by the following equation:
P=100×[1−ρ({M_{R}/ρ_{R}}+{1−M_{R}}/ρₘ)]
in which:
P is the porosity in %;
ρ is the density of the mat in g/cm³;
ρ_{R} is the density of the reinforcement in g/cm³;
ρₘ is the density of the thermoplastic in g/cm³;
M_{R} is the mass fraction of the reinforcement.

The reinforcing substance is understood to mean here a substance having a melting point or degradation point higher than that of the aforementioned thermoplastic substance. In general, the reinforcement is a substance commonly used for reinforcing thermoplastics, such as glass, carbon, aramid, ceramics and plant fibers, for example flax, sisal and hemp. Preferably, the chosen substance is glass.

The thermoplastic may be any substance capable of being converted into fibers. For example, this may be polyethylene, polypropylene, polyethylene terephthalate, polybutylene terephthalate, polyphenylene sulfide, a polymer chosen from polyamides and from thermoplastic polyesters, or any other substance having a thermoplastic nature.

According to the invention, the mat comprises at least one reinforcing substance and at least one thermoplastic substance, one and/or both of these substances being able to be in the form of continuous yarns or chopped yarns. These yarns may consist completely or partly of yarns comprising one or more reinforcing substances and of yarns consisting of one or more thermoplastic substances. Preferably, the yarns consist of filaments of a reinforcing substance and of filaments of a thermoplastic substance, for example a mixture of yarns obtained by simultaneously combining and winding yarns of one of the substances and yarns of the other substance, or commingled yarns consisting of intimately mixed filaments of one or more reinforcing substances and filaments of one or more thermoplastic substances.

Advantageously, the yarns of the mat comprise at least 50%, or preferably at least 80% and particularly preferably 100% by weight of commingled yarns.

Also preferably, the commingled yarns consist of glass filaments and filaments of a thermoplastic organic substance, preferably polypropylene.

Advantageously, the filaments forming part of the commingled yarns have a uniform distribution within the yarn. The manufacture of such yarns is described, for example, in patents EP-A-0 599 695, EP-A-0 616 055 and FR-A-2 815 046.

In general, the reinforcing substance (preferably glass) represents at least 10%, preferably 30% to 85% and advantageously 40% to 75% by weight of the deformable mat.

In general, the chopped yarns have a length of less than 100 mm, preferably between 20 and 60 mm.

The yarns making up the web may be bonded together using various means, as will be indicated below.

The deformable mat according to the invention may be obtained by the process comprising the steps consisting in:
depositing, on a moving substrate, at least one continuous yarn and/or chopped yarns comprising at least one reinforcing substance and at least one thermoplastic substance in order to form a web;
subjecting the web to a treatment for bonding the yarns together in order to form a deformable mat; and
collecting the mat.

The deposition of the continuous yarn or yarns is carried out in the direction of movement of the substrate, in the form of superposed loops by means of a suitable known device, for example by means of an air-intake yarn-spraying device, for example a Venturi device, or a device undergoing an oscillatory motion, preferably placed downstream of a device for conveying the yarn at a constant speed.

The deposition of the chopped yarns may be carried out by introducing yarns, unwound or laid out from packages, for example packages of rovings, into a chopper suited to the type of yarn. Any type of known chopper may be used, for example a device in which the yarn is chopped by blades placed in a ring, over which the yarn is wound beforehand and pressed by a press roll coated with an elastomer, or a chopper operating by shearing the yarn between blades mounted on a rotor or on a guillotine and a stationary counterblade.

The treatment used for bonding the yarns must preserve the integrity of the reinforcing filaments so that they fulfill the reinforcing function required of them. This is a “light” bonding, which must avoid giving the final mat an excessive amount of cohesion, as the latter no longer has the flexibility required for correctly following the interior of the mold during the molding operation. The treatment conditions must therefore be tailored so that the mat exhibits the intended “deformability”.

According to a first preferred variant, the yarns are stitch-bonded by means of a binding thread that is finer than the yarns of the web, for example, a yarn having a linear density of between 40 and 300 dtex. The yarn may consist of a reinforcing substance, for example an aramid, or of a thermoplastic organic substance, for example polypropylene, polyester or polyamide. Stitches exhibiting elasticity are preferred, for example, by knitting using the Malimo technique with a flat yarn or better still with a “texturized” yarn exhibiting intrinsic elasticity. Preferably, the yarns employed by this stitching/knitting method are spaced apart by about 5 mm in the machine direction and by about 7 mm in the direction transverse to the movement of the web.

According to a second variant, the bonding is carried out by a mechanical treatment, which allows the constituent filaments of the yarns to be slightly entangled, such as moderate needle punching or exposure to pressurized water jets.

With regard to needle punching, any suitable device may be used, for example, a support provided with needles undergoing a vertical reciprocal movement, which needles, passing through the web, cause intermingling of the filaments. For “heavy” products, two supports facing each other placed on either side of the web, are used for symmetrical needle punching.

The entangling by exposure to pressurized-water jets may be carried out by blasting water onto the web which is placed on a perforated support or passing over a metal belt, and the water jets bouncing off the belt, causing moderate intermingling of the yarns.

According to a third variant, the bonding is carried out by corona discharge. To do this, the web is brought into contact with an electrode roll equipped with spikes that are subjected to a high frequency, high voltage. The discharges cause localized melting of the thermoplastic organic substance at the spikes, allowing the yarns to be bonded together, the bonding remaining sufficiently tenuous for the mat to maintain flexibility compatible with the molding operation. It is also possible to obtain an equivalent result using ultrasonic electrodes undergoing a reciprocal or rotary movement. To give an example, satisfactory bonding is obtained with 4 spikes/cm², preferably 1 to 2 spikes/cm², the spikes having a length of less than 2 mm, preferably 1 mm.

According to a fourth variant, an adhesive that develops its adhesive properties when hot (i.e. a hot-melt adhesive) is provided. In general, the adhesive has a melting point below that of that material of the yarns having the lowest melting point; it is also chemically compatible with the latter. The adhesive may be liquid or solid, for example a powder, a film or a veil. The treatment temperature is generally 10 to 40° C. below the melting point of that material of the yarns having the lowest melting point.

The mat obtained after the bonding treatment is sufficiently flexible to be wound onto a support, for example, a tube of small diameter, possibly ranging from 50 to 150 mm.

This mat furthermore has a weight per unit area of at least 700 g/m², preferably less than 4000 g/m², and advantageously ranging from 1500 to 3000 g/m².

Because the mat according to the invention is deformable and compact, it is well suited for the production of deeply indented parts and/or those of complex configuration by molding, especially vacuum molding or compression molding.

In vacuum molding, the mat is placed on or in the unheated mold (i.e. at room temperature) and then the actual molding is carried out by heating the mold to a temperature above the melting point of the thermoplastic substance, while maintaining the vacuum in the mold. In this case, placing the mat in the mold is particularly easy owing to the fact that it has a high deformability—it is possible to stretch the mat so that it conforms as closely as possible to the reliefs of the mold without damaging it, in particular without tearing it or forming pleats.

In compression molding, the mat is heated to a temperature above the melting point of the thermoplastic substance before being introduced into the mold, which is also heated to a temperature of around 70 to 80° C., and the application of a counter mold allows the molded part to be obtained. The mat according to the invention has the advantage of being able to be easily deformed and thus of ensuring uniform distribution of the yarns in the final part, while still maintaining sufficient cohesion for it to be handled at indicated temperatures and not to “collapse” under gravity when it is introduced into the mold.

The mat according to the invention makes it possible to obtain molded parts having the desired thickness, without flaws such as “holes” or surface asperities, and having completely satisfactory mechanical properties, especially textural strength and impact strength.

Other advantages and features of the invention will become apparent in the light of the figures and the example that follow, these being given merely by way of illustration.

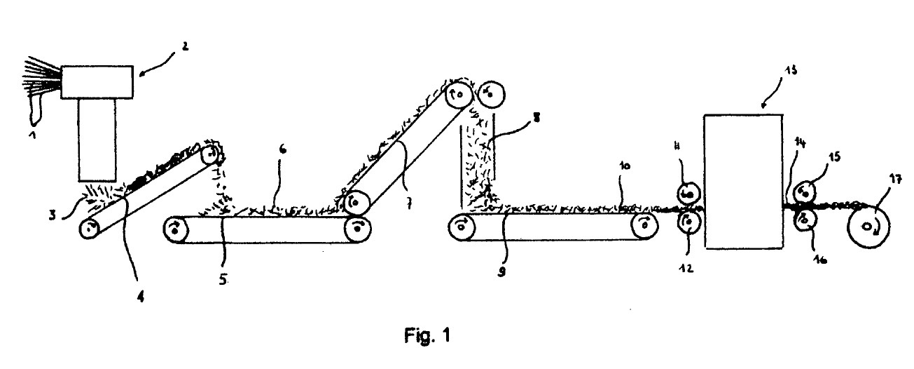

FIG. 1 shows a schematic view of a device according to a first embodiment of the invention.

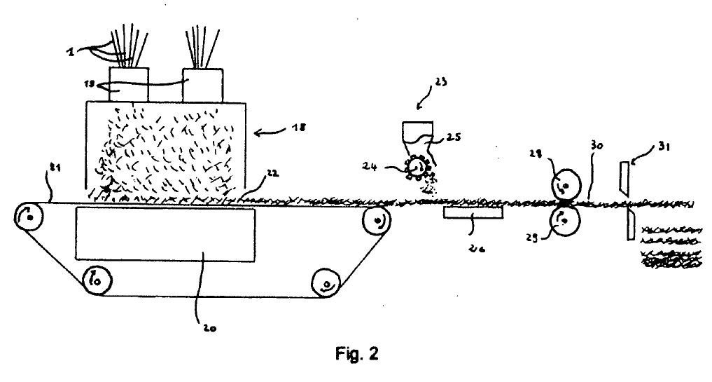

FIG. 2 shows a schematic view of a device according to a variant of the first embodiment of the invention.

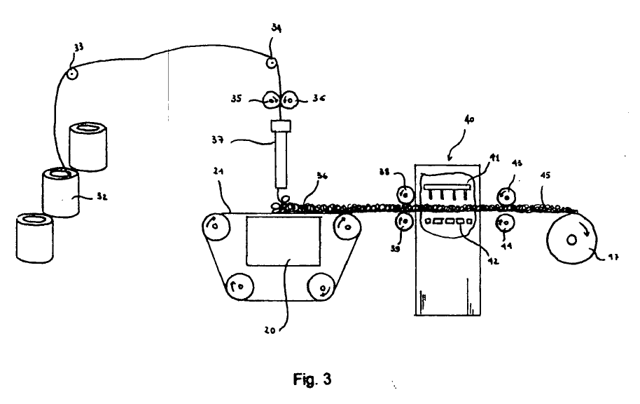

FIG. 3 shows a schematic view of a device according to a second embodiment of the invention.

In the figures, the elements in common bear the same references.

In FIG. 1, the commingled yarns 1 coming from packages (not shown) enter the chopper 2. The chopped yarns 3 drop onto the belt 4 and are sent toward the conveyer 5. The belt 4 is driven in a transverse reciprocal movement allowing the chopped yarns to be uniformly distributed over the entire conveyer 5. The web 6 of chopped yarns is taken up by the belt 7, the surface of which is covered with surface needles, and then it is introduced into the spreader chute 8. The chute may be equipped with a weigh feeder device (not shown) which controls the flow rate of the chopped yarns. The chopped yarns leaving the chute 8 are deposited on the conveyer 9, forming the web 10 that passes between the rolls 11 and 12 before entering the machine 13 where it is stitch-bonded. The mat 15, guided by the forwarding rolls 15, 16, is wound up in the form of a reel 17.

In FIG. 2, the commingled yarns 1 are introduced into the enclosure 18 via ducts 19 provided with choppers (not shown). The suction box 20 under the belt 21, which is provided with perforations, ensures that the web 22 of chopped yarns is held in place on the belt.

The web 22 then passes beneath a powder coater 23 composed of a cylinder provided with grooves 24, this device being joined to the base of a reservoir 25 filled with the hot-melt binder powder, then over the vibrating table 26, which ensures that the powder penetrates into the web, and finally into the calender 27 composed of two heated rolls 28, 29. The formed mat 30 is cut into segments by the blade 31.

In FIG. 3, the commingled yarn 1 coming from the roving 32 is placed on a creel (not shown), is guided by rollers 33, 34 and passes between the forwarding rolls 35, 36 at a constant speed.

The yarn penetrates a Venturi-type intake device 37 that throws the yarn onto the belt 21 in the form of loops. The action of the suction box 20 helps to keep the looped web 36 in place on the belt 21. The web passes between the forwarding rolls 38, 39 and then into a needle-punching device 40, which comprises a support 41 provided with needles and a perforated plate 42 for passage of the needles through the web. Downstream of the forwarding rolls 43, 44, the mat 45 is collected in the form of a reel 17.

For the sake of clarity only one yarn has been shown. However, it would not be outside the scope of the invention for there to be several yarns individually guided and projected onto the belt 21 by means of the aforementioned members.

### EXAMPLE 1

A deformable mat was produced using the device of FIG. 1.

Commingled yarns (Twintex®, comprising 60% glass by weight and 40% polypropylene by weight and having a linear density of 1870 tex) coming from rovings placed on a creel were chopped in the chopper 2 to a length of 50 mm.

The chopped yarns forming the web 10 are bonded by the stitch-bonding device 13 (Malimo) by stitching it with a polyester texturized yarn (linear density: 167 dtex). The stitches had a length of 5 mm and the rows of stitching were separated by 7 mm. The mat was wound up on a tube 90 mm in diameter. It had a mean thickness of 3.5 mm, a weight per unit area of around 1500 g/m² and a porosity of 71%. The mat had an elongation of around 100% in any direction whatsoever, measured under the conditions in the ISO 3342 (1995) standard.

### EXAMPLE 2

A deformable mat was produced using the device of FIG. 3.

Commingled yarns (Twintex®, comprising 60% glass by weight and 40% black polypropylene by weight, with a linear density of 1870 tex) coming from rovings were individually thrown in loops onto the belt 21 by means of Venturi nozzles 37. The web 36 was bonded by needle punching (penetration depth: 20 mm with 70 strikes/cm²). The mat 45 obtained was collected in the form of a reel 17.

The mat obtained had a mean thickness of 6.5 mm, a weight per unit area of around 3000 g/m² and a porosity of 69%. It had an elongation at break of 80% measured under the conditions indicated in Example 1.

1-16. (canceled)

17: A deformable mat of at least one web comprising:
at least one reinforcing substance and at least one thermoplastic substance, these substances being in a form of at least one continuous yarn and/or chopped yarns, and the yarns being bonded together so that the mat has an elongation at break in all directions of at least 50%.

18: The mat as claimed in claim 17, wherein the mat has an elongation at break in all directions varying from 100% to 150%.

19: The mat as claimed in claim 17, wherein the yarns consist completely or partly of filaments of a reinforcing substance and filaments of a thermoplastic substance.

20: The mat as claimed in claim 19, wherein the yarns comprise at least 50%, or at least 80%, by weight of commingled yarns.

21: The mat as claimed in claim 20, wherein the commingled yarns consist of glass filaments and filaments of a thermoplastic organic substance or polypropylene.

22: The mat as claimed in claim 17, containing at least 10%, or 30% to 85%, by weight of reinforcing substance.

23: The mat as claimed in claim 17, wherein the chopped yarns have a length of less than 100 mm, or between 20 and 60 mm.

24: The mat as claimed in claim 17, having a porosity ranging from 65 to 80%.

25: The mat as claimed in claim 17,
having a weight per unit area of at least 700 g/m², or less than 4000 g/m².

26: A process for manufacturing a deformable mat as claimed in claim 17, which comprises:
depositing, on a moving substrate, at least one continuous yarn and/or chopped yarns including at least one reinforcing substance and at least one thermoplastic substance to form a web;
subjecting the web to a treatment for bonding the yarns together in order to form a deformable mat; and
collecting the material.

27: The process as claimed in claim 26, wherein the yarn bonding treatment is carried out by stitch-bonding with a binding thread that is finer than the yarns of the web.

28: The process as claimed in claim 27, wherein the binding thread has a linear density of between 40 and 300 dtex and the bonding is carried out by stitching.

29: The process as claimed in claim 26, wherein the yarn bonding treatment is carried out mechanically, by moderate needle punching or by exposure to pressurized water jets.

30: The process as claimed in claim 26, wherein the yarn bonding treatment is carried out by localized melting of the thermoplastic substance, especially by corona discharge or by ultrasound.

31: The process as claimed in claim 26, wherein the yarn bonding treatment is carried out by provision of a hot-melt adhesive.

32: The use of the material as claimed in claim 26 for manufacturing composite parts by molding.

33: The use as claimed in claim 32, wherein the molding is vacuum molding or compression molding.
